(19) United States
(12) Patent Application Publication
(10) Pub. No.: US 2008/0001378 A1
(43) Pub. Date: Jan. 3, 2008

(54) BUILT-UP WHEEL CONTROL ARM

(76) Inventors: Jurgen SCHMITZ, Osnabruck (DE); Frank Nachbar, Lemforde (DE); Bernhard Eilers, Twistringen (DE); Jorg Tumoset, Oldendorf (DE); Martin Wellerding, Damme (DE); Karl-Heinz Kallwass, Hulsede (DE); Toralf Huttner, Osnabruck (DE); Luzian Kobier, Osnabruck (DE); Rafael Teijeiro Castro, Burgos (ES); Jose' Ramon Izquierdo Nunez, Burgos (ES)

Correspondence Address: MCGLEW & TUTTLE, PC, P.O. BOX 9227, SCARBOROUGH STATION, SCARBOROUGH, NY, 10510-9227, US

(21) Appl. No.: 10/598,361

(22) PCT Filed: Feb. 25, 2005
(86) PCT No.: PCT/DE05/00332

§ 371 Date: Jul. 19, 2007

(30) Foreign Application Priority Data
Feb. 25, 2004 (DE) 102004 009 723.2

(51) Int. Cl. B60G 7/00; B60G 7/02

(52) U.S. Cl. 280/124.134; 280/86.757

(57) ABSTRACT

A control arm (12) is provided especially for the wheel suspension of a motor vehicle. The control arm (12) includes at least two connection points (13, 14, 15) for the pivotingly movable connection of the control arm 12 to a body structure and to a wheel guide component as well as a strut arrangement, which connects the connection points. The control arm strut arrangement is composed of at least two strut parts (17, 18, 19), wherein the strut parts are designed as separate profiled parts with an essentially flat or open cross-sectional shape. This presents a modular system for the design and the manufacture of control arms of extensively any desired shape for axle systems and wheel suspensions of motor vehicles. Relatively no appreciable tool costs are incurred for generating variants of control arms or new control arm structural shapes.

### CROSS REFERENCE TO RELATED APPLICATIONS

This application is a United States National Phase application of International Application PCT/DE2005/000332 and claims the benefit of priority under 35 U.S.C. § 119 of German Patent Application 10 2004 009 723.2 filed Feb. 25, 2004, the entire contents of which are incorporated herein by reference.

### FIELD OF THE INVENTION

The present invention pertains to a control arm, for example, a suspension arm, especially for the wheel suspension of a motor vehicle

### BACKGROUND OF THE INVENTION

Control arms of the type mentioned in the introduction are used in nearly all types of motor vehicles as well as in nearly all wheel suspensions of motor vehicles. Such control arms, for example, suspension arms, but also longitudinal control arms, control arms of spatial rod axles and the like, have the task at the motor vehicle of connecting the respective corresponding wheel or the wheel carrier of the corresponding wheel to the body structure such that only the degrees of freedom intended by the design will be left for the wheel or the wheel carrier. These degrees of freedom consist most essentially of a free mobility of the wheel or wheel carrier in the vertical direction in order to thus make it possible to compensate the motions of the wheel that are due to unevennesses of the road surface.

Such wheel control arms are essentially of a one-part design in the overwhelming majority of cases; they are designed, in particular, as one-part drop forgings, as one-part castings or as one-shell or two-shell deep-drawn sheet metal components.

However, different designs, types of construction, dimensions, materials and qualities of wheel control arms are necessary for nearly every motor vehicle model in view of the currently reached complexity and differences of commercially available motor vehicles. Wheel control arms with just as different properties, load-bearing capacities, materials and/or dimensions are frequently needed even within one and the same line of a motor vehicle because of different levels of equipment, different engines, different drive concepts, different track widths or even because of different auxiliary units or installation conditions.

However, this causes the manufacturer or the supplier of wheel control arms to be forced to design and manufacture or stock a large number of different wheel control arms time and time again. However, the consequence of this is, especially in case of the essentially one-part wheel control arms common in the state of the art, that different tools are also needed for manufacturing the particular wheel control arm for every individual design of a wheel control arm. Since wheel control arms are comparatively large-surface components made of high-value and resistant materials, which also have, however, a complicated shape and are subject to extremely high loads, the tools for manufacturing one-part wheel control arms usually correspondingly require great efforts, are correspondingly complicated and consequently both expensive and tend to be error-prone.

However, the rising cost and deadline pressure in the design, manufacture and stocking of components and systems of motor vehicles calls for the search for inexpensive, flexible solutions for wheel control arms, but the required high quality of the wheel control arms must also be maintained or even further increased at the same time as a consequence of the customers' demands.

### SUMMARY OF THE INVENTION

Against this background, the object of the present invention is to provide a wheel control arm with which the drawbacks can be overcome. The control arm shall be able to be manufactured in an especially simple and inexpensive manner, and the extremely high tool costs for the manufacture of the wheel control arm, which are common in the state of the art, shall not be incurred. In addition, the wheel control arm shall be able to be manufactured efficiently as well as with high cost effectiveness even in case of small lot sizes, and the shortest possible time intervals shall be able to be achieved between specification, supplying of samples and manufacture.

The control arm according to the present invention comprises, at first in the known manner per se, at least two connection points, which are used for the mobile connection of the control arm to a body structure of a motor vehicle, on the one hand, and to a wheel guide component, on the other hand. The wheel guide component may be, for example, a steering knuckle, a wheel carrier or a spring strut. Likewise at first in a known manner per se, the control arm comprises a strut arrangement. The strut arrangement is used to connect the at least two connection points of the control arm.

The control arm is characterized according to the present invention in that the strut arrangement is composed of at least two strut parts (strut means). The strut means are designed as separate profiled parts with essentially flat or open cross-sectional shape.

In other words, this means that the control arm does not have a one-part strut arrangement, but the strut arrangement of the control arm is composed of at least two separate strut means, wherein the strut means are in the form of geometrically comparatively simple profiled parts. The strut means or the profiled parts can thus be manufactured separately from one another by means of comparatively simple, standardized and consequently inexpensive tools. However, the present invention also brings with it especially the decisive advantage that the strut means that are in the form of separate profiled parts can be used to manufacture a large number of different control arms without an essential change in the profiled parts or strut means as well as without essential changes in the manufacture tools for the strut means.

For example, it is thus possible thanks to the present invention to manufacture suspension arms of different geometric shapes, with different dimensions or with different track width without any modification whatsoever in the strut means that the suspension arm comprises. To manufacture such different suspension arms from unchanged individual parts, the profiled parts or strut means of the control arm are connected to one another in respective different arrangements or in different relative positions.

It is advantageous in this connection if, as this is provided in an especially preferred embodiment of the present invention, the strut means can be connected to one another in at least two different relative positions or relative angles. If the same strut means are used, it is thus possible to manufacture control arms with already two different geometries or at least two different dimensions. The number of variants that can thus be manufactured increases correspondingly in the case of control arms that comprise more than two strut means, which can be connected to one another each in at least two different relative positions or relative angles.

According to another, especially preferred embodiment of the present invention, the strut means can be connected to one another in a plurality of different relative positions or relative angles within a range of adjustment. An even greater number of variants of control arms can thus be manufactured with the same strut means, again without changes being necessary on the tools with which the strut means are manufactured. It is thus also possible, for example, to manufacture control arm designs that can be set to different dimensions, for example, to different track widths of different models of a motor vehicle line.

In principle, any desired large number of different variants of wheel control arms can be manufactured within a range of variants, as this is also provided for by another preferred embodiment of the present invention, if the strut means can be connected to one another within a range of adjustment in continuously selectable relative positions or relative angles. Fine adjustment of, e.g., the axle geometry or the track width can thus also be performed on the basis of corresponding changes in the relative position of the strut means of the control arm.

It is advantageous in this connection, as this is also provided for by another preferred embodiment of the present invention, if the control arm has a locking means with a plurality of locking steps that can be snapped in in a spring-loaded or elastic manner. The strut means can be brought into position at predetermined distances from one another by the locking means before the strut means are finally connected to one another. Such a locking means facilitates the assembly of the strut means and leads to better reproducibility of the provided relative position of the strut means within one type of construction of the control arm.

In what manner the connection of the individual strut means and consequently the final setting of the geometry, type of construction and dimension of the control arm are finally performed is not essential at first for the present invention as long as the connection is appropriate for the loads occurring during the operation of the control arm. Thus, the individual strut means may be connected to one another especially in a non-positive or positive-locking manner or by connection in substance.

However, the strut means can be connected detachably according to a preferred embodiment of the present invention. This is advantageous both concerning a subsequent adjustment of the relative position of the strut means, for example, for changing the track width or the axle geometry, and the repair of the control arm or the replacement of individual control arm components or strut means because of damage or wear.

According to another preferred embodiment ofthe present invention, the strut means of a control arm are connected to one another in substance. The connection in substance of the strut means, especially welding, is to be preferably used advantageously if a subsequent change in the geometry or the dimensions of the control arm are not considered, which is the case, for example, in the quantity manufacture of a certain control arm design for a certain motor vehicle.

According to another, likewise preferred embodiment of the present invention, the strut means are calked with one another without auxiliary material. This type of connection of the strut means is especially advantageous because the components are not subject to thermal load, as during welding, which tends to be harmful, and it is also unnecessary to manufacture comparatively complicated screw or riveted connections. The strut means are rather connected in this embodiment, for example, by the so-called Tox clinching, in which the sheet metals to be connected are connected to one another by means of a special tool in a rivet-like manner by deformation causing a punctiform meshing, but without auxiliary material. Calking can just as well be carried without auxiliary material, for example, also in the form of the known beading or clamping.

The manner in which the strut means are positioned in relation to one another before the final connection of the strut means is established is at first not of essential significance for the present invention. For example, it is thus conceivable to position the strut means in relation to one another by means of a device and to subsequently connect the strut means to one another in the position thus fixed, for example, by connection in substance or in a positive-locking manner.

However, at least two strut means of the control arm can be pushed into one another in a connecting rod-like or telescopic manner. This design facilitates, on the one hand, the preassembly and the prefixation of the strut means before these are finally connected to one another. On the other hand, the strut means can thus be brought into different relative positions in relation to one another in the simplest manner conceivable, as a result of which control arms with different geometries or different dimensions can be manufactured in a simple manner. In addition, the shape of the profiled parts forming the strut means that enables these parts to be pushed into one another in a connecting rod-like or telescopic manner increases the flexural strength and the torsional stiffiess as well as the buckling strength of the strut or strut arrangement thus formed.

According to another embodiment of the present invention, at least two strut means of the control arm can be pushed into one another in a connecting rod-like or telescopic manner along a circular arc. Besides the already mentioned advantages of the connecting rod-like or telescopic shape, this shape has additionally the advantage that arc-shaped control arm geometries and more complex adjustabilities of a control arm can also be designed in this manner.

According to another preferred embodiment of the present invention, at least two strut means are connected to one another by means of pressed-in collars that mesh with one another. This manner of connection of the strut means is especially advantageous insofar as the pressed-in collars or pressed-in openings necessary for this can be manufactured in an especially simple manner by deep-drawing, and insofar as a connection of the strut means that is both extremely robust and can also be established in an especially simple manner and is, moreover, adjustable in angle is made possible in this manner.

According to another preferred embodiment of the present invention, at least two strut means can be connected to one another by means of at least one additional strut means. Many different structural shapes of control arms, especially also steering triangles and the like, can be designed and manufactured in this manner.

The present invention will be explained in more detail below on the basis of drawings, which show only exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of two strut means of a first embodiment of a control arm according to the present invention;

FIG. 2 is a schematic view of a cross section through the strut means according to FIG. 1;

FIG. 3 is a schematic view of a cross section through the strut means of another embodiment of a control arm according to the present invention;

FIG. 4 is a schematic view of a cross section through the strut means of a third embodiment of a control arm according to the present invention;

FIG. 5 is two strut means of a fourth embodiment of a control arm according to the present invention in a view corresponding to FIG. 1;

FIG. 6 is a schematic view of an embodiment of a steering triangle according to the present invention;

FIG. 7 is a schematic enlarged view of the cross section A-A through the control arm according to FIG. 6; and

FIG. 8 is the cross section B-B through the control arm according to FIG. 6 in a view corresponding to FIG. 7.

### DESCRIPTION OF THE PREFERRED EMBODIMENTS

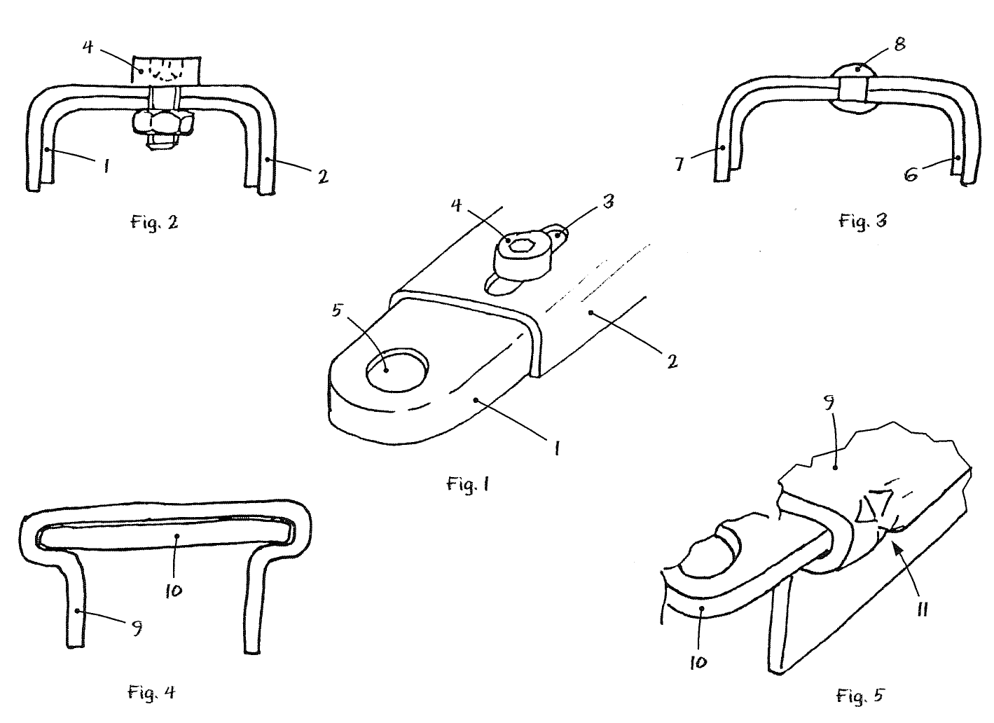

Referring to the drawings in particular, FIG. 1 schematically shows two profiled parts 1, 2 or strut means 1, 2 of a control arm with the features according to the present invention. The two profiled parts 1, 2 are connected to one another by means of the elongated hole 3 and the screw 4, as this is also shown by the cross section through the profiled parts 1, 2 according to FIG. 1, which cross section is shown in FIG. 2. The profiled parts 1, 2 thus form a part of the strut arrangement of a wheel control arm, which is shown only partially here, for example, a bar-type control arm or even a steering triangle.

It can be recognized that the profiled parts 1, 2 of the control arm according to the present invention are, contrary to the state of the art, in the form of profiles 1, 2 that can be manufactured in a comparatively simple manner by beveling or deep-drawing. The hole 5 in the profiled part 1 is used to connect the control arm to a body structure or to a wheel guide component, for example, to a steering knuckle, a wheel carrier or a spring strut, for example, by means of a ball-and-socket joint or an elastomer joint.

It already appears from the view in FIG. 1 that a wheel control arm designed according to the present invention in such a way can be adapted to different requirements, for example, it can be used for different track widths of different motor vehicle models within one line of vehicles. A wheel control arm built according to FIGS. 1 and 2 has the additional advantage that the control arm can also be adjusted, in principle, subsequently in the operating state of the motor vehicle, for example in order to adapt the axle geometry.

FIG. 3 shows the cross section through the strut means or profiled parts 6, 7 of another embodiment of a control arm designed according to the present invention. The connection between the profiled parts 6, 7 is established in this control arm at the time of the manufacture of the control arm once and for all nondetachably by means of a rivet connection 8. However, diverse control arms with different dimensions or with different shapes can also be manufactured in this case with the same strut means by placing the holes for the rivet 8 or for additional rivets present in correspondingly different locations.

FIG. 4 shows the cross section through the strut means or profiled parts 9, 10 of another embodiment of a control arm according to the present invention. It is recognized that the profiled part 9 is beveled such that it forms a prismatic guide, into which the profiled part 10 can be pushed in a connecting rod-like or telescopic manner. On the one hand, this facilitates the preassembly of the two profiled parts 9, 10 before the final connection of the profiled parts 9, 10 during the manufacture of the control arm and, on the other hand, it increases the flexural strength and the torsional stiffiess as well as the buckling strength of the control arm strut or strut device thus formed.

The profiled parts 9, 10 according to FIG. 4 may be connected to one another, for example, by clamping or beading, as this appears from the view in FIG. 5. It is recognized that after the profiled part 10 has been pushed into the prismatic guide formed by the profiled part 9 and after the subsequent positioning of the profiled part 10 in the profiled part 9, a nondetachable connection is established between the two profiled parts 9, 10 by pressing the edges of the prismatic guide at 11.

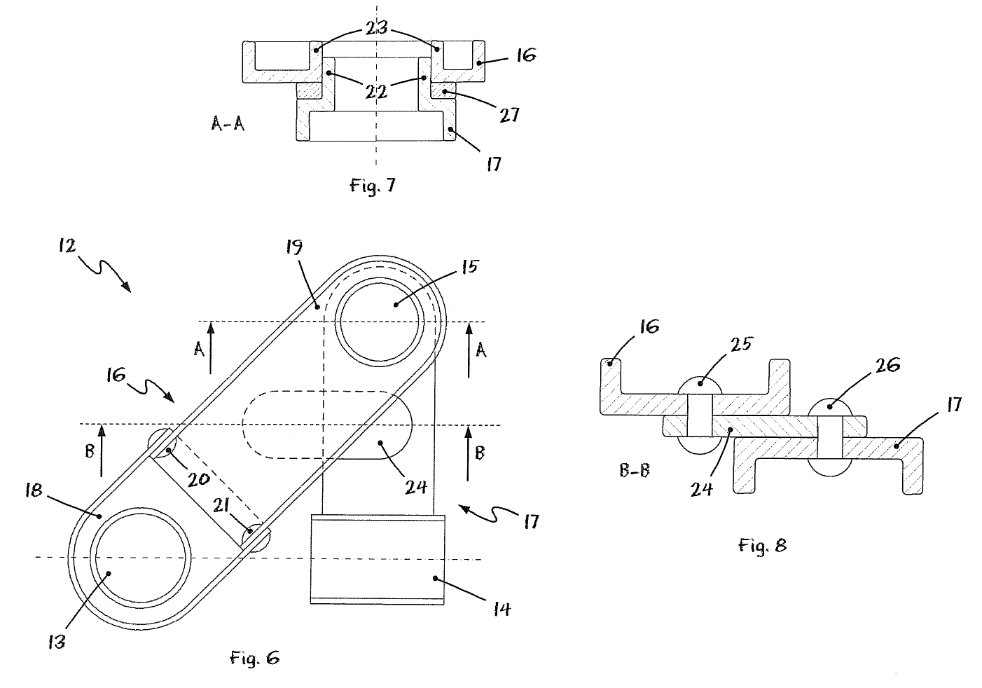

FIG. 6 shows another embodiment of a control arm 12 according to the present invention. It is a steering triangle 12 for a motor vehicle, wherein the control arm has a total of three connection points 13, 14, 15. Of the connection points, the two connection points 13, 14 are used, for example, to receive rubber-metal bearings for connecting the suspension arm 12 to a body structure, while the third connection point 15 is used to receive, for example, a ball and socket joint, which can be connected to a wheel carrier and whose bolt or ball shell can, for example, be pressed or welded in.

It can be clearly recognized that the control arm 12 according to FIG. 6 has a completely modular design, the individual components of the control arm 12 according to FIG. 6 being able to originate especially from a comprehensive modular system that is based on the present invention, whose components make possible the problem-free design and manufacture of control arms of practically any desired shape, form and size. The control arm 12 according to FIG. 6 comprises a strut arrangement formed initially from two struts 16, 17, the two struts 16, 17 forming an angle of 45° in the exemplary embodiment being shown.

The strut 16 is again composed here of two strut means or profiled parts 18, 19, which are connected to one another by rivets 20, 21, similar to what was already shown in FIG. 3. This means, of course, just as in the arrangement according to FIG. 3, that this strut 16, formed by riveting two profiled parts 18, 19, can be formed without changing its basic components with different lengths by correspondingly placing only the holes for the rivets 20, 21.

The strut 16 composed of the two profiled parts 18, 19 is connected to the other strut 17 initially by means of pressed-in collars 22, 23, which mesh with one another, as this is schematically shown in the enlarged sectional view shown in FIG. 7 along line A-A in FIG. 6. Viewing FIGS. 6 and 7 together shows how the pressed-in collars 22, 23 made in one piece with the two struts 16, 17 mesh with one another and thus form a robust, but initially still angularly adjustable connection between the two struts 16, 17.

The task of fixing the two struts 16, 17 connected to one another by means of the pressed-in collars 22, 23 in respect to the intended angle between the two struts 16, 17 is performed by another component 24 of the control arm, which originates from the control arm modular system. This stabilizing component 24 is in turn connected to the two struts 16, 17, for example, by rivets 25, 26 and thus leads to the angular fixation and stabilization of the two struts 16, 17. To additionally stiffen the control arm, the connection formed by the pressed-in collars 22, 23 between the two struts 16, 17 can be additionally fixed permanently, for example, by pressing or welding together the two pressed-in collars 22, 23 meshing with one another.

The annular component 27 that is additionally recognizable in FIG. 7 is used as a spacer between the two control arm struts corresponding to the distance between the two control arm struts 16, 17, which is necessary because of the additional stabilizing component 24 arranged between the two struts 16, 17.

As a result, it thus becomes clear that the present invention makes it possible to design and manufacture any number of different control arms, especially for axle systems and wheel suspensions of motor vehicles, without appreciable tool costs being incurred for manufacturing another variant. Due to the fact that the same modular components can be used multiply for manufacturing a great variety of control arms as well as based on the comparatively simple shape of the control arm components, the small amount of waste generated, which is made possible hereby, as well as because of the comparatively simple tools associated herewith, these components can be manufactured at extremely favorable costs in very large, predictable lots.

The greatest possible variety of variants of control arms with flexible geometry can thus be achieved with only a few basic elements.

Thus, the present invention makes a very substantial contribution to the improvement of productivity in the area of wheel suspensions and axle systems. At the same time, it is possible to respond to customers' demands more quickly, more simply and in a more flexible manner thanks to the present invention.

While specific embodiments of the invention have been shown and described in detail to illustrate the application of the principles of the invention, it will be understood that the invention may be embodied otherwise without departing from such principles.

In the claims:

1. A control arm for the wheel suspension of a motor vehicle, the control arm comprising:
at least two connection points for the pivotingly movable connection of the control arm to a body structure and to a wheel guide component; and,
a strut arrangement connecting the at least two said connection points said strut arrangement comprising at least two strut parts, wherein the strut parts are designed as separate profiled parts with an essentially flat or open cross-sectional shape.

2. A control arm in accordance with claim 1, wherein the strut parts can be connected to one another in at least two different positions or relative angles.

3. A control arm in accordance with claim 1, wherein the strut parts can be connected to one another in a plurality of different relative positions or relative angles within a range of adjustment to provide one of a plurality of dimensional relationships between said at least two connection points.

4. A control arm in accordance with claim 1, wherein the strut parts can be connected to one another in continuously selectable relative positions or relative angles within a range of adjustment.

5. A control arm in accordance with claim 1, by further comprising a locking part with a plurality of locking steps that snap in, in a spring-loaded manner, or elastically for prefixing the strut parts in the intended relative positions.

6. A control arm in accordance with claim 1, wherein the strut parts can be connected detachably.

7. A control arm in accordance with claim 5, wherein the strut parts are connected to one another by connection in substance.

8. A control arm in accordance with claim 5, wherein the strut parts are calked with one another without auxiliary material.

9. A control arm in accordance with claim 1, wherein at least two said strut parts can be pushed into one another in a connecting rod-like or telescopic manner.

10. A control arm in accordance with claim 1, wherein at least two said strut parts can be pushed into one another in a connecting rod-like or telescopic manner along a circular arc.

11. A control arm in accordance claim 1 with, wherein at least two said strut parts are connected to one another by means of said pressed-in collars (22, 23) that mesh with one another.

12. A control arm in accordance with claim 1, wherein at least two said strut parts can be connected to one another by means of at least one said other strut parts (24).

13. A motor vehicle suspension control arm, comprising:
first connection structure;
second connection structure; and
a strut arrangement connecting said first connection structure to said second connection structure, said strut arrangement comprising a first strut part with an essentially flat or open cross-sectional shape, a second strut part with an essentially flat or open cross-sectional shape and a connection means for connecting said first strut part to said second strut part in any one of a plurality of arrangements to set a position of said first strut part relative to said second strut part.

14. A control arm in accordance with claim 13, wherein said connection means includes a locking part with a plurality of locking steps that snap in, in a spring-loaded manner, or elastically for prefixing the strut parts in the intended relative positions.

15. A control arm in accordance with claim 13, wherein said connection means comprises a connection in substance.

16. A control arm in accordance with claim 13, wherein said connection means comprises deformed or shaped portions of at least one of said first strut part to said second strut part.

17. A control arm in accordance with claim 13, wherein said first strut part is shaped to receive said second strut part in a connecting rod-like or telescopic manner.

18. A control arm in accordance with claim 13 wherein said first strut part is shaped to receive said second strut part in a connecting rod-like or telescopic manner along a circular arc.

19. A control arm in accordance with claim 13, wherein said connection means comprises a Tox clinching of said first strut part to said second strut part.

20. A control arm in accordance claim 1 wherein said connection means comprises pressed-in collars of said first strut part and said second strut part that mesh with one another.
